(19) United States
(12) Patent Application Publication
(10) Pub. No.: US 2026/0112088 A1
(43) Pub. Date: Apr. 23, 2026

(54) SYSTEM

(71) Applicant: SoftBank Group Corp., Tokyo (JP)

(72) Inventor: Fumika BEPPU, Tokyo (JP)

(21) Appl. No.: 19/353,250

(22) Filed: Oct. 8, 2025

(30) Foreign Application Priority Data
Oct. 18, 2024 (JP) 2024-183943

(51) Int. Cl. G06T 11/60; G06F 3/16

(52) U.S. Cl. CPC G06T 11/60; G06F 3/167

(57) ABSTRACT

The system according to the embodiment includes an image generation unit, a dataset addition unit, a prompt input unit, and a response determination unit. The image generation unit generates images for irregular events. The dataset addition unit adds images generated by the image generation unit to a dataset. The prompt input unit inputs situations during driving as prompts. The response determination unit determines an appropriate response based on the situation input by the prompt input unit.

### CROSS-REFERENCE TO RELATED APPLICATION

The present application claims priority to and incorporates by reference the entire contents of Japanese Patent Application No. 2024-183943 filed in Japan on October 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, responses to irregular events in autonomous driving have not been sufficiently addressed, and there is room for improvement.

### SUMMARY OF THE INVENTION

The system according to the embodiment includes an image generation unit, a dataset addition unit, a prompt input unit, and a response determination unit. The image generation unit generates images for irregular events. The dataset addition unit adds images generated by the image generation unit to a dataset. The prompt input unit inputs situations during driving as prompts. The response determination unit determines an appropriate response based on the situation input by the prompt input unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as "processor") may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, "A and/or B" means "at least one of A and B." In other words, "A and/or B" means it may be only A, only B, or a combination of A and B. Moreover, when expressing three or more items connected by "and/or," the same concept as "A and/or B" applies.

### First Embodiment

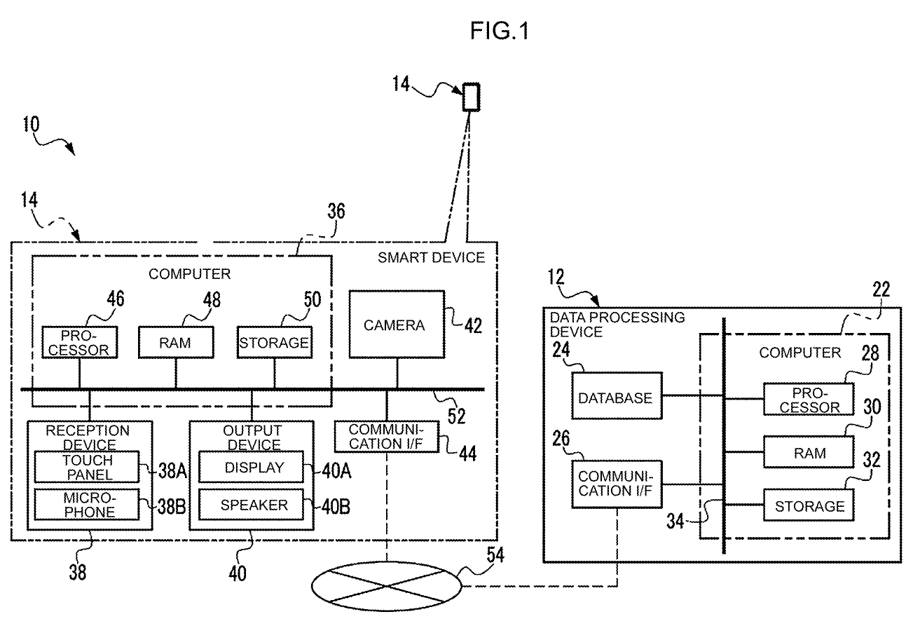

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

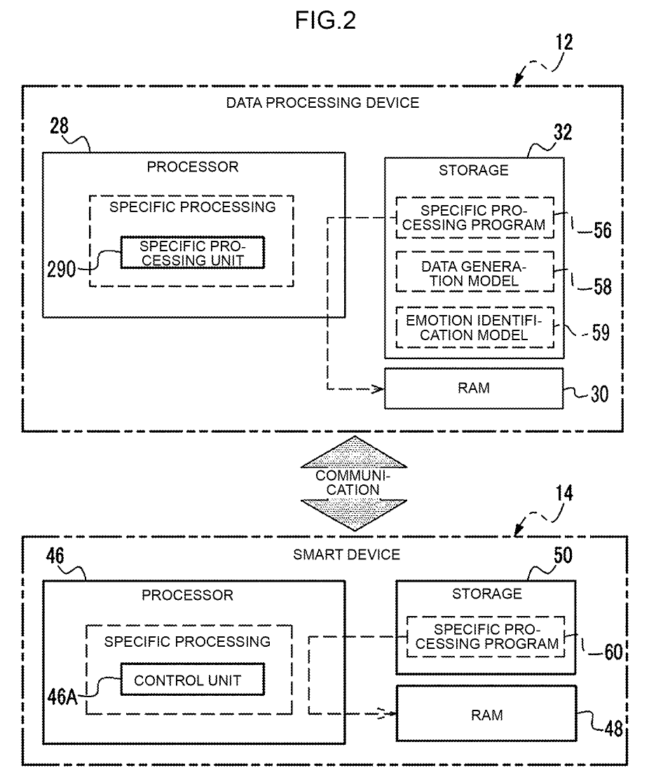

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The autonomous driving system according to the embodiment of the present invention proposes a method for improving the recognition accuracy of AI-based autonomous driving. The autonomous driving system can handle driving under normal conditions, but lacks recognition accuracy for irregular situations. To solve this problem, two methods utilizing generative AI are proposed. First is a method for generating images for irregular events. Using generative AI, images reproducing irregular situations that are not included in normal datasets are generated. For example, generative AI can reproduce situations such as animals suddenly jumping onto the road or driving conditions under abnormal weather. This enables the AI to handle irregular situations that it has not learned before. The second method is to input situations during driving as prompts. Irregular situations occurring during driving are input to the generative AI in real time as prompts using speech recognition technology. For example, a situation such as "There is an obstacle ahead" can be input by voice during driving, and the generative AI determines an appropriate response based on that situation. This enables quick responses to irregular situations during driving. These methods improve the recognition accuracy of AI-based autonomous driving and make it possible to realize a world of autonomous driving with minimal misrecognition. Specifically, the following steps are included. First, images for irregular events are generated using generative AI. Next, the generated images are added to the dataset and used for AI training. This enables the AI to handle irregular situations. Furthermore, irregular situations occurring during driving are input to the generative AI as prompts using speech recognition technology, and the generative AI determines an appropriate response based on the situation. For example, if "An animal suddenly jumped out ahead" is input by voice during driving, the generative AI determines an appropriate response based on that situation and supports driving. In addition, by adding images of irregular situations generated by the generative AI to the dataset, the AI can handle situations it has not learned before. With this mechanism, the recognition accuracy of AI-based autonomous driving is improved, and a world of autonomous driving with minimal misrecognition can be realized. For example, the AI can now handle irregular situations such as animals suddenly jumping onto the road or driving conditions under abnormal weather, which it could not handle before. This improves the safety of autonomous driving and enables more people to use autonomous driving with peace of mind. Thus, the autonomous driving system can improve the recognition accuracy of AI-based autonomous driving and realize a world of autonomous driving with minimal misrecognition.

The autonomous driving system according to the embodiment includes an image generation unit, a dataset addition unit, a prompt input unit, and a response determination unit. The image generation unit generates images for irregular events. For example, the image generation unit generates images reproducing irregular situations that are not included in normal datasets using generative AI. For example, the image generation unit generates images reproducing situations where animals suddenly jump onto the road. The image generation unit can also generate images reproducing driving conditions under abnormal weather. For example, the image generation unit generates images reproducing driving conditions in heavy rain or snow. Furthermore, the image generation unit can generate images reproducing driving conditions at night or in fog using generative AI. The dataset addition unit adds images generated by the image generation unit to a dataset. For example, the dataset addition unit integrates the generated images into an existing dataset and trains the AI. For example, the dataset addition unit adds the generated images to the dataset so that the AI can handle irregular situations. The dataset addition unit can also classify the generated images and add them to appropriate categories. For example, the dataset addition unit classifies the generated images into categories such as traffic accidents, natural disasters, and mechanical failures. The prompt input unit inputs situations during driving as prompts. For example, the prompt input unit inputs irregular situations occurring during driving to the generative AI in real time as prompts using speech recognition technology. For example, the prompt input unit inputs situations such as "There is an obstacle ahead" by voice during driving. The prompt input unit can also input situations such as "The road is slippery" by voice during driving. Furthermore, the prompt input unit can input situations such as "Visibility is poor" by voice during driving. The response determination unit determines an appropriate response based on the situation input by the prompt input unit. For example, the response determination unit determines an appropriate response based on the situation input to the generative AI. For example, the response determination unit instructs to take evasive action if there is an obstacle ahead. The response determination unit can also instruct to reduce speed if the road is slippery. Furthermore, the response determination unit can instruct to turn on the lights if visibility is poor. Thus, the autonomous driving system according to the embodiment enables image generation for irregular events, dataset addition, prompt input, and response determination.

The image generation unit generates images for irregular events. For example, the image generation unit generates images reproducing irregular situations that are not included in normal datasets using generative AI. Specifically, the generative AI generates images based on a large pre-learned dataset in response to specific prompts. For example, when generating images reproducing situations where animals suddenly jump onto the road, the generative AI generates realistic images by considering the type and movement of the animal, the road conditions, and so on. The image generation unit can also generate images reproducing driving conditions under abnormal weather. For example, when generating images reproducing driving conditions in heavy rain or snow, the generative AI reproduces details such as the way rain or snow falls, poor visibility, and slippery road surfaces. Furthermore, when generating images reproducing driving conditions at night or in fog, the generative AI generates realistic images by considering light reflection, limited visibility, fog density, and so on. In this way, the image generation unit generates images reproducing various irregular situations that are not included in normal datasets and can utilize them as training data for the autonomous driving system.

The dataset addition unit adds images generated by the image generation unit to a dataset. For example, the dataset addition unit integrates the generated images into an existing dataset and trains the AI. Specifically, the generated images are converted into an appropriate format and added to the existing dataset. For example, the generated images are classified into categories such as traffic accidents, natural disasters, and mechanical failures, and added to the corresponding datasets. The dataset addition unit also manages metadata of the generated images, recording information such as the generation date and time, generation conditions, and prompt content. This enables efficient management of training data for the AI to handle irregular situations. Furthermore, the dataset addition unit can evaluate the quality of the generated images and perform filtering or correction as necessary. For example, if the generated images are unclear or contain incorrect information, appropriate corrections are made to ensure quality before adding them to the dataset. In this way, the dataset addition unit can effectively integrate the generated images into the dataset and improve the learning accuracy of the AI.

The prompt input unit inputs situations during driving as prompts. For example, the prompt input unit inputs irregular situations occurring during driving to the generative AI in real time as prompts using speech recognition technology. Specifically, when the driver reports a situation by voice, the speech recognition system converts the content into text and inputs it to the generative AI. For example, when inputting a situation such as "There is an obstacle ahead" by voice during driving, the speech recognition system accurately recognizes the content and provides it to the generative AI as a prompt. Similarly, when inputting a situation such as "The road is slippery" by voice, the speech recognition system converts the content into text and inputs it to the generative AI. Furthermore, when inputting a situation such as "Visibility is poor" by voice, the speech recognition system accurately recognizes the content and provides it to the generative AI as a prompt. In this way, the prompt input unit can input irregular situations during driving to the generative AI in real time and provide information for determining an appropriate response.

The response determination unit determines an appropriate response based on the situation input by the prompt input unit. For example, the response determination unit determines an appropriate response based on the situation input to the generative AI. Specifically, the generative AI refers to past data and learning results based on the input prompt and calculates the optimal response. For example, if there is an obstacle ahead, the generative AI instructs to take evasive action based on past data. If the road is slippery, the generative AI can instruct to reduce speed. Furthermore, if visibility is poor, the generative AI can instruct to turn on the lights. In this way, the response determination unit can determine an appropriate response in real time based on the information provided by the prompt input unit and issue instructions to the autonomous driving system. The response determination unit can also handle cases where multiple prompts are input simultaneously. For example, if there is an obstacle ahead and the road is slippery, the generative AI determines the optimal response considering both situations. The response determination unit can also incorporate feedback from past response results and continuously learn to improve response accuracy. In this way, the response determination unit can always provide highly accurate response determination based on the latest information and improve the safety and reliability of the autonomous driving system.

A generative AI unit configured to generate images using generative AI is provided. The generative AI unit generates images reproducing irregular situations that are not included in normal datasets using generative AI. For example, the generative AI unit generates images reproducing situations where animals suddenly jump onto the road. The generative AI unit can also generate images reproducing driving conditions under abnormal weather. For example, the generative AI unit generates images reproducing driving conditions in heavy rain or snow. Furthermore, the generative AI unit can generate images reproducing driving conditions at night or in fog using generative AI. In this way, the use of generative AI improves the accuracy of image generation. Some or all of the above-described processing in the generative AI unit may be performed using generative AI or without using generative AI. For example, the generative AI unit can add images generated using generative AI to the dataset and train the AI.

A speech recognition unit configured to input situations using speech recognition technology is provided. The speech recognition unit inputs irregular situations occurring during driving to the generative AI in real time as prompts using speech recognition technology. For example, the speech recognition unit inputs situations such as "There is an obstacle ahead" by voice during driving. The speech recognition unit can also input situations such as "The road is slippery" by voice during driving. Furthermore, the speech recognition unit can input situations such as "Visibility is poor" by voice during driving. In this way, the use of speech recognition technology improves the accuracy of situation input. Some or all of the above-described processing in the speech recognition unit may be performed using AI or without using AI. For example, the speech recognition unit can input situations entered using speech recognition technology to the generative AI, and the generative AI can determine an appropriate response based on the situation.

A dataset management unit configured to add generated images to the dataset is provided. The dataset management unit integrates the generated images into an existing dataset and trains the AI. For example, the dataset management unit adds the generated images to the dataset so that the AI can handle irregular situations. The dataset management unit can also classify the generated images and add them to appropriate categories. For example, the dataset management unit classifies the generated images into categories such as traffic accidents, natural disasters, and mechanical failures. In this way, the use of the dataset management unit improves the efficiency of dataset management. Some or all of the above-described processing in the dataset management unit may be performed using AI or without using AI. For example, the dataset management unit can input the generated images to the AI, and the AI can classify the images and add them to the dataset.

A response determination AI unit configured to determine an appropriate response based on the situation during driving is provided. The response determination AI unit determines an appropriate response based on the situation input to the generative AI. For example, the response determination AI unit instructs to take evasive action if there is an obstacle ahead. The response determination AI unit can also instruct to reduce speed if the road is slippery. Furthermore, the response determination AI unit can instruct to turn on the lights if visibility is poor. In this way, the use of the response determination AI unit enables quick determination of appropriate responses. Some or all of the above-described processing in the response determination AI unit may be performed using AI or without using AI. For example, the response determination AI unit can determine an appropriate response based on the situation input to the generative AI and instruct the driver accordingly.

The image generation unit can generate images reproducing irregular situations that are not included in normal datasets. For example, the image generation unit generates images reproducing irregular situations that are not included in normal datasets using generative AI. For example, the image generation unit generates images reproducing situations where animals suddenly jump onto the road. The image generation unit can also generate images reproducing driving conditions under abnormal weather. For example, the image generation unit generates images reproducing driving conditions in heavy rain or snow. Furthermore, the image generation unit can generate images reproducing driving conditions at night or in fog using generative AI. In this way, generating images reproducing irregular situations improves the recognition accuracy of the AI. Some or all of the above-described processing in the image generation unit may be performed using generative AI or without using generative AI. For example, the image generation unit can add images generated using generative AI to the dataset and train the AI.

The prompt input unit can input irregular situations occurring during driving to the generative AI in real time as prompts using speech recognition technology. For example, the prompt input unit inputs situations such as "There is an obstacle ahead" by voice during driving. The prompt input unit can also input situations such as "The road is slippery" by voice during driving. Furthermore, the prompt input unit can input situations such as "Visibility is poor" by voice during driving. In this way, inputting prompts in real time enables quick responses. Some or all of the above-described processing in the prompt input unit may be performed using generative AI or without using generative AI. For example, the prompt input unit can input situations entered using speech recognition technology to the generative AI, and the generative AI can determine an appropriate response based on the situation.

The response determination unit can determine an appropriate response based on the situation input to the generative AI. For example, the response determination unit determines an appropriate response based on the situation input to the generative AI. For example, the response determination unit instructs to take evasive action if there is an obstacle ahead. The response determination unit can also instruct to reduce speed if the road is slippery. Furthermore, the response determination unit can instruct to turn on the lights if visibility is poor. In this way, the use of generative AI enables quick determination of appropriate responses. Some or all of the above-described processing in the response determination unit may be performed using generative AI or without using generative AI. For example, the response determination unit can determine an appropriate response based on the situation input to the generative AI and instruct the driver accordingly.

The image generation unit can reproduce more diverse irregular events by including visual information from different viewpoints and angles in the generated images. For example, the image generation unit generates images including visual information from different viewpoints and angles using generative AI. For example, the image generation unit generates images reproducing traffic congestion from an overhead view of the road. The image generation unit can also generate images reproducing congestion in a parking lot from a side view of a vehicle. Furthermore, the image generation unit can generate images reproducing congestion at a crosswalk from a pedestrian's viewpoint. In this way, including visual information from different viewpoints and angles enables reproduction of more diverse irregular events. Some or all of the above-described processing in the image generation unit may be performed using generative AI or without using generative AI. For example, the image generation unit can add images generated using generative AI to the dataset and train the AI.

The image generation unit can provide more realistic scenarios by reflecting different times of day and seasonal changes in the generated images. For example, the image generation unit generates images reflecting different times of day and seasonal changes using generative AI. For example, the image generation unit generates images reproducing nighttime road conditions. The image generation unit can also generate images reproducing snowy road conditions in winter. Furthermore, the image generation unit can generate images reproducing road conditions with fallen leaves in autumn. In this way, reflecting different times of day and seasonal changes provides more realistic scenarios. Some or all of the above-described processing in the image generation unit may be performed using generative AI or without using generative AI. For example, the image generation unit can add images generated using generative AI to the dataset and train the AI.

The image generation unit can provide more diverse scenarios by reflecting different traffic conditions and road conditions in the generated images. For example, the image generation unit generates images reflecting different traffic conditions and road conditions using generative AI. For example, the image generation unit generates images reproducing road conditions during traffic congestion. The image generation unit can also generate images reproducing road conditions during construction. Furthermore, the image generation unit can generate images reproducing road conditions at accident sites. In this way, reflecting different traffic conditions and road conditions provides more diverse scenarios. Some or all of the above-described processing in the image generation unit may be performed using generative AI or without using generative AI. For example, the image generation unit can add images generated using generative AI to the dataset and train the AI.

The image generation unit can provide more realistic scenarios by reflecting different weather conditions in the generated images. For example, the image generation unit generates images reflecting different weather conditions using generative AI. For example, the image generation unit generates images reproducing road conditions during rain. The image generation unit can also generate images reproducing road conditions on snowy days. Furthermore, the image generation unit can generate images reproducing road conditions in fog. In this way, reflecting different weather conditions provides more realistic scenarios. Some or all of the above-described processing in the image generation unit may be performed using generative AI or without using generative AI. For example, the image generation unit can add images generated using generative AI to the dataset and train the AI.

The dataset addition unit can add a function to automatically generate and manage metadata of images when adding them to the dataset. For example, the dataset addition unit automatically generates metadata such as the date and time and location of image capture and adds it to the dataset. The dataset addition unit can also automatically generate tags related to the content of the image and add them to the dataset. Furthermore, the dataset addition unit can automatically generate metadata such as image resolution and format information and add it to the dataset. In this way, automatically generating and managing image metadata improves the efficiency of dataset management. Some or all of the above-described processing in the dataset addition unit may be performed using AI or without using AI. For example, the dataset addition unit can input image metadata to the AI, and the AI can generate the metadata and add it to the dataset.

The dataset addition unit can add a function to evaluate the quality of images to be added to the dataset and automatically exclude low-quality images. For example, the dataset addition unit automatically excludes images with low resolution. The dataset addition unit can also automatically exclude images with a lot of noise. Furthermore, the dataset addition unit can automatically exclude blurry images. In this way, automatically excluding low-quality images improves the quality of the dataset. Some or all of the above-described processing in the dataset addition unit may be performed using AI or without using AI. For example, the dataset addition unit can input image quality to the AI, and the AI can evaluate the quality and exclude low-quality images.

The dataset addition unit can add a function to evaluate the relevance of images when adding them to the dataset and preferentially add highly relevant images. For example, the dataset addition unit preferentially adds images whose content is related to the current driving situation to the dataset. The dataset addition unit can also preferentially add images whose content is related to past driving history. Furthermore, the dataset addition unit can preferentially add images whose content is related to specific driving scenarios. In this way, preferentially adding highly relevant images improves the quality of the dataset. Some or all of the above-described processing in the dataset addition unit may be performed using AI or without using AI. For example, the dataset addition unit can input image relevance to the AI, and the AI can evaluate the relevance, select highly relevant images, and add them to the dataset.

The dataset addition unit can add a function to evaluate the diversity of images when adding them to the dataset and preferentially add highly diverse images. For example, the dataset addition unit preferentially adds images taken from different viewpoints and angles to the dataset. The dataset addition unit can also preferentially add images reflecting different times of day and seasonal changes to the dataset. Furthermore, the dataset addition unit can preferentially add images reflecting different traffic conditions and road conditions to the dataset. In this way, preferentially adding highly diverse images improves the quality of the dataset. Some or all of the above-described processing in the dataset addition unit may be performed using AI or without using AI. For example, the dataset addition unit can input image diversity to the AI, and the AI can evaluate the diversity, select highly diverse images, and add them to the dataset.

The prompt input unit can refer to the driver's past driving history when inputting prompts and generate optimal prompts. For example, the prompt input unit preferentially provides prompts that were used in similar situations in the past. The prompt input unit can also provide prompts used at specific times or locations based on past driving history. Furthermore, the prompt input unit can analyze past driving history and provide the most effective prompts. In this way, referring to past driving history enables optimal prompts to be provided. Some or all of the above-described processing in the prompt input unit may be performed using AI or without using AI. For example, the prompt input unit can input the driver's past driving history to the AI, and the AI can analyze the history and generate optimal prompts.

The prompt input unit can analyze the driver's current driving situation in real time when inputting prompts and generate optimal prompts. For example, the prompt input unit analyzes the current traffic situation in real time and provides appropriate prompts. The prompt input unit can also analyze the current weather conditions in real time and provide appropriate prompts. Furthermore, the prompt input unit can analyze the current road conditions in real time and provide appropriate prompts. In this way, analyzing the current driving situation in real time enables optimal prompts to be provided. Some or all of the above-described processing in the prompt input unit may be performed using AI or without using AI. For example, the prompt input unit can input the driver's current driving situation to the AI, and the AI can analyze the situation in real time and generate optimal prompts.

The prompt input unit can generate optimal prompts by considering the driver's geographic location information when inputting prompts. For example, the prompt input unit provides appropriate prompts by considering the current traffic situation at the current location. The prompt input unit can also provide appropriate prompts by considering the current weather conditions at the current location. Furthermore, the prompt input unit can provide appropriate prompts by considering the current road conditions at the current location. In this way, considering geographic location information enables optimal prompts to be provided. Some or all of the above-described processing in the prompt input unit may be performed using AI or without using AI. For example, the prompt input unit can input the driver's geographic location information to the AI, and the AI can generate optimal prompts based on the information.

The prompt input unit can analyze the driver's social media activity when inputting prompts and generate relevant prompts. For example, the prompt input unit provides appropriate prompts based on information shared by the driver on social media. The prompt input unit can also analyze the driver's social media activity history and provide relevant prompts. Furthermore, the prompt input unit can provide appropriate prompts based on information from accounts followed by the driver on social media. In this way, analyzing social media activity enables relevant prompts to be provided. Some or all of the above-described processing in the prompt input unit may be performed using AI or without using AI. For example, the prompt input unit can input the driver's social media activity to the AI, and the AI can analyze the activity and generate relevant prompts.

The response determination unit can refer to past response history when determining a response and select the optimal response. For example, the response determination unit preferentially selects responses that were taken in similar situations in the past. The response determination unit can also select responses taken at specific times or locations based on past response history. Furthermore, the response determination unit can analyze past response history and select the most effective response. In this way, referring to past response history enables optimal responses to be provided. Some or all of the above-described processing in the response determination unit may be performed using AI or without using AI. For example, the response determination unit can input past response history to the AI, and the AI can analyze the history and select the optimal response.

The response determination unit can analyze the current driving situation in real time when determining a response and select the optimal response. For example, the response determination unit analyzes the current traffic situation in real time and selects an appropriate response. The response determination unit can also analyze the current weather conditions in real time and select an appropriate response. Furthermore, the response determination unit can analyze the current road conditions in real time and select an appropriate response. In this way, analyzing the current driving situation in real time enables optimal responses to be provided. Some or all of the above-described processing in the response determination unit may be performed using AI or without using AI. For example, the response determination unit can input the current driving situation to the AI, and the AI can analyze the situation in real time and select the optimal response.

The response determination unit can select the optimal response by considering the driver's geographic location information when determining a response. For example, the response determination unit selects an appropriate response by considering the current traffic situation at the current location. The response determination unit can also select an appropriate response by considering the current weather conditions at the current location. Furthermore, the response determination unit can select an appropriate response by considering the current road conditions at the current location. In this way, considering geographic location information enables optimal responses to be provided. Some or all of the above-described processing in the response determination unit may be performed using AI or without using AI. For example, the response determination unit can input the driver's geographic location information to the AI, and the AI can generate the optimal response based on the information.

The response determination unit can analyze the driver's social media activity when determining a response and select relevant responses. For example, the response determination unit selects an appropriate response based on information shared by the driver on social media. The response determination unit can also analyze the driver's social media activity history and select relevant responses. Furthermore, the response determination unit can select an appropriate response based on information from accounts followed by the driver on social media. In this way, analyzing social media activity enables relevant responses to be provided. Some or all of the above-described processing in the response determination unit may be performed using AI or without using AI. For example, the response determination unit can input the driver's social media activity to the AI, and the AI can analyze the activity and generate relevant responses.

The system according to the embodiment is not limited to the above-described examples and can be variously modified as follows, for example.

The autonomous driving system can analyze the driver's past driving history and provide optimal driving assistance based on the driver's driving style. For example, for drivers who frequently use sudden braking in the past, the system provides assistance to encourage deceleration in advance. For drivers who frequently drive on highways in the past, the system can provide assistance to maintain optimal following distance on highways. Furthermore, for drivers who frequently drive at night in the past, the system can provide assistance to improve nighttime visibility. In this way, providing assistance according to the driver's driving style can improve driving safety and comfort. The analysis of driving history may be performed using AI or without using AI. For example, driving history data can be input to the AI, and the AI can analyze the data and generate optimal driving assistance.

The autonomous driving system can refer to the driver's past driving history and propose optimal routes based on the driver's driving patterns. For example, for drivers who frequently use a specific route in the past, the system preferentially proposes that route. For drivers who tend to avoid traffic congestion in the past, the system can propose routes that avoid congestion. Furthermore, for drivers who prefer to use highways in the past, the system can propose routes that use highways. In this way, proposing optimal routes according to the driver's driving patterns can improve driving efficiency and comfort. The reference to driving history may be performed using AI or without using AI. For example, driving history data can be input to the AI, and the AI can analyze the data and generate optimal routes.

The autonomous driving system can analyze the driver's current driving situation in real time and provide optimal driving assistance. For example, the system analyzes the current traffic situation in real time and provides assistance to avoid congestion. The system can also analyze the current weather conditions in real time and provide driving assistance in bad weather. Furthermore, the system can analyze the current road conditions in real time and provide assistance to avoid road construction or accidents. In this way, analyzing the current driving situation in real time enables optimal driving assistance to be provided. The real-time analysis of driving situation may be performed using AI or without using AI. For example, driving situation data can be input to the AI, and the AI can analyze the data in real time and generate optimal driving assistance.

The autonomous driving system can provide optimal driving assistance by considering the driver's geographic location information. For example, the system provides assistance to avoid congestion by considering the current traffic situation at the current location. The system can also provide driving assistance in bad weather by considering the current weather conditions at the current location. Furthermore, the system can provide assistance to avoid road construction or accidents by considering the current road conditions at the current location. In this way, considering geographic location information enables optimal driving assistance to be provided. The consideration of geographic location information may be performed using AI or without using AI. For example, geographic location information data can be input to the AI, and the AI can analyze the data and generate optimal driving assistance.

The autonomous driving system can analyze the driver's social media activity and provide optimal driving assistance based on the driver's interests and preferences. For example, the system proposes routes to places of interest based on information shared by the driver on social media. The system can also analyze the driver's social media activity history and provide relevant driving assistance. Furthermore, the system can propose routes to events or places of interest based on information from accounts followed by the driver on social media. In this way, analyzing social media activity enables driving assistance based on the driver's interests and preferences to be provided. The analysis of social media activity may be performed using AI or without using AI. For example, social media activity data can be input to the AI, and the AI can analyze the data and generate optimal driving assistance.

The following is a brief description of the processing flow of Example 1 of the Embodiment.

Step 1: The image generation unit generates images for irregular events. For example, images reproducing irregular situations that are not included in normal datasets are generated using generative AI. Specifically, images reproducing situations such as animals suddenly jumping onto the road or driving conditions under abnormal weather (driving in heavy rain or snow, at night, or in fog) are generated.

Step 2: The dataset addition unit adds images generated by the image generation unit to a dataset. For example, the generated images are integrated into an existing dataset and used for AI training. The generated images are also classified and added to appropriate categories such as traffic accidents, natural disasters, and mechanical failures.

Step 3: The prompt input unit inputs situations during driving as prompts. For example, irregular situations occurring during driving are input to the generative AI in real time as prompts using speech recognition technology. Specifically, situations such as "There is an obstacle ahead," "The road is slippery," and "Visibility is poor" are input by voice.

Step 4: The response determination unit determines an appropriate response based on the situation input by the prompt input unit. For example, the response determination unit determines an appropriate response based on the situation input to the generative AI, instructs to take evasive action if there is an obstacle ahead, instructs to reduce speed if the road is slippery, and instructs to turn on the lights if visibility is poor.

### Example 2 of Embodiment

The autonomous driving system according to the embodiment of the present invention proposes a method for improving the recognition accuracy of AI-based autonomous driving. The autonomous driving system can handle driving under normal conditions, but lacks recognition accuracy for irregular situations. To solve this problem, two methods utilizing generative AI are proposed. First is a method for generating images for irregular events. Using generative AI, images reproducing irregular situations that are not included in normal datasets are generated. For example, generative AI can reproduce situations such as animals suddenly jumping onto the road or driving conditions under abnormal weather. This enables the AI to handle irregular situations that it has not learned before. The second method is to input situations during driving as prompts. Irregular situations occurring during driving are input to the generative AI in real time as prompts using speech recognition technology. For example, a situation such as "There is an obstacle ahead" can be input by voice during driving, and the generative AI determines an appropriate response based on that situation. This enables quick responses to irregular situations during driving. These methods improve the recognition accuracy of AI-based autonomous driving and make it possible to realize a world of autonomous driving with minimal misrecognition. Specifically, the following steps are included. First, images for irregular events are generated using generative AI. Next, the generated images are added to the dataset and used for AI training. This enables the AI to handle irregular situations. Furthermore, irregular situations occurring during driving are input to the generative AI as prompts using speech recognition technology, and the generative AI determines an appropriate response based on the situation. For example, if "An animal suddenly jumped out ahead" is input by voice during driving, the generative AI determines an appropriate response based on that situation and supports driving. In addition, by adding images of irregular situations generated by the generative AI to the dataset, the AI can handle situations it has not learned before. With this mechanism, the recognition accuracy of AI-based autonomous driving is improved, and a world of autonomous driving with minimal misrecognition can be realized. For example, the AI can now handle irregular situations such as animals suddenly jumping onto the road or driving conditions under abnormal weather, which it could not handle before. This improves the safety of autonomous driving and enables more people to use autonomous driving with peace of mind. Thus, the autonomous driving system can improve the recognition accuracy of AI-based autonomous driving and realize a world of autonomous driving with minimal misrecognition.

The autonomous driving system according to the embodiment includes an image generation unit, a dataset addition unit, a prompt input unit, and a response determination unit. The image generation unit generates images for irregular events. For example, the image generation unit generates images reproducing irregular situations that are not included in normal datasets using generative AI. For example, the image generation unit generates images reproducing situations where animals suddenly jump onto the road. The image generation unit can also generate images reproducing driving conditions under abnormal weather. For example, the image generation unit generates images reproducing driving conditions in heavy rain or snow. Furthermore, the image generation unit can generate images reproducing driving conditions at night or in fog using generative AI. The dataset addition unit adds images generated by the image generation unit to a dataset. For example, the dataset addition unit integrates the generated images into an existing dataset and trains the AI. For example, the dataset addition unit adds the generated images to the dataset so that the AI can handle irregular situations. The dataset addition unit can also classify the generated images and add them to appropriate categories. For example, the dataset addition unit classifies the generated images into categories such as traffic accidents, natural disasters, and mechanical failures. The prompt input unit inputs situations during driving as prompts. For example, the prompt input unit inputs irregular situations occurring during driving to the generative AI in real time as prompts using speech recognition technology. For example, the prompt input unit inputs situations such as "There is an obstacle ahead" by voice during driving. The prompt input unit can also input situations such as "The road is slippery" by voice during driving. Furthermore, the prompt input unit can input situations such as "Visibility is poor" by voice during driving. The response determination unit determines an appropriate response based on the situation input by the prompt input unit. For example, the response determination unit determines an appropriate response based on the situation input to the generative AI. For example, the response determination unit instructs to take evasive action if there is an obstacle ahead. The response determination unit can also instruct to reduce speed if the road is slippery. Furthermore, the response determination unit can instruct to turn on the lights if visibility is poor. Thus, the autonomous driving system according to the embodiment enables image generation for irregular events, dataset addition, prompt input, and response determination.

The image generation unit generates images for irregular events. For example, the image generation unit generates images reproducing irregular situations that are not included in normal datasets using generative AI. Specifically, the generative AI generates images based on a large pre-learned dataset in response to specific prompts. For example, when generating images reproducing situations where animals suddenly jump onto the road, the generative AI generates realistic images by considering the type and movement of the animal, the road conditions, and so on. The image generation unit can also generate images reproducing driving conditions under abnormal weather. For example, when generating images reproducing driving conditions in heavy rain or snow, the generative AI reproduces details such as the way rain or snow falls, poor visibility, and slippery road surfaces. Furthermore, when generating images reproducing driving conditions at night or in fog, the generative AI generates realistic images by considering light reflection, limited visibility, fog density, and so on. In this way, the image generation unit generates images reproducing various irregular situations that are not included in normal datasets and can utilize them as training data for the autonomous driving system.

The dataset addition unit adds images generated by the image generation unit to a dataset. For example, the dataset addition unit integrates the generated images into an existing dataset and trains the AI. Specifically, the generated images are converted into an appropriate format and added to the existing dataset. For example, the generated images are classified into categories such as traffic accidents, natural disasters, and mechanical failures, and added to the corresponding datasets. The dataset addition unit also manages metadata of the generated images, recording information such as the generation date and time, generation conditions, and prompt content. This enables efficient management of training data for the AI to handle irregular situations. Furthermore, the dataset addition unit can evaluate the quality of the generated images and perform filtering or correction as necessary. For example, if the generated images are unclear or contain incorrect information, appropriate corrections are made to ensure quality before adding them to the dataset. In this way, the dataset addition unit can effectively integrate the generated images into the dataset and improve the learning accuracy of the AI.

The prompt input unit inputs situations during driving as prompts. For example, the prompt input unit inputs irregular situations occurring during driving to the generative AI in real time as prompts using speech recognition technology. Specifically, when the driver reports a situation by voice, the speech recognition system converts the content into text and inputs it to the generative AI. For example, when inputting a situation such as "There is an obstacle ahead" by voice during driving, the speech recognition system accurately recognizes the content and provides it to the generative AI as a prompt. Similarly, when inputting a situation such as "The road is slippery" by voice, the speech recognition system converts the content into text and inputs it to the generative AI. Furthermore, when inputting a situation such as "Visibility is poor" by voice, the speech recognition system accurately recognizes the content and provides it to the generative AI as a prompt. In this way, the prompt input unit can input irregular situations during driving to the generative AI in real time and provide information for determining an appropriate response.

The response determination unit determines an appropriate response based on the situation input by the prompt input unit. For example, the response determination unit determines an appropriate response based on the situation input to the generative AI. Specifically, the generative AI refers to past data and learning results based on the input prompt and calculates the optimal response. For example, if there is an obstacle ahead, the generative AI instructs to take evasive action based on past data. If the road is slippery, the generative AI can instruct to reduce speed. Furthermore, if visibility is poor, the generative AI can instruct to turn on the lights. In this way, the response determination unit can determine an appropriate response in real time based on the information provided by the prompt input unit and issue instructions to the autonomous driving system. The response determination unit can also handle cases where multiple prompts are input simultaneously. For example, if there is an obstacle ahead and the road is slippery, the generative AI determines the optimal response considering both situations. The response determination unit can also incorporate feedback from past response results and continuously learn to improve response accuracy. In this way, the response determination unit can always provide highly accurate response determination based on the latest information and improve the safety and reliability of the autonomous driving system.

A generative AI unit configured to generate images using generative AI is provided. The generative AI unit generates images reproducing irregular situations that are not included in normal datasets using generative AI. For example, the generative AI unit generates images reproducing situations where animals suddenly jump onto the road. The generative AI unit can also generate images reproducing driving conditions under abnormal weather. For example, the generative AI unit generates images reproducing driving conditions in heavy rain or snow. Furthermore, the generative AI unit can generate images reproducing driving conditions at night or in fog using generative AI. In this way, the use of generative AI improves the accuracy of image generation. Some or all of the above-described processing in the generative AI unit may be performed using generative AI or without using generative AI. For example, the generative AI unit can add images generated using generative AI to the dataset and train the AI.

A speech recognition unit configured to input situations using speech recognition technology is provided. The speech recognition unit inputs irregular situations occurring during driving to the generative AI in real time as prompts using speech recognition technology. For example, the speech recognition unit inputs situations such as "There is an obstacle ahead" by voice during driving. The speech recognition unit can also input situations such as "The road is slippery" by voice during driving. Furthermore, the speech recognition unit can input situations such as "Visibility is poor" by voice during driving. In this way, the use of speech recognition technology improves the accuracy of situation input. Some or all of the above-described processing in the speech recognition unit may be performed using AI or without using AI. For example, the speech recognition unit can input situations entered using speech recognition technology to the generative AI, and the generative AI can determine an appropriate response based on the situation.

A dataset management unit configured to add generated images to the dataset is provided. The dataset management unit integrates the generated images into an existing dataset and trains the AI. For example, the dataset management unit adds the generated images to the dataset so that the AI can handle irregular situations. The dataset management unit can also classify the generated images and add them to appropriate categories. For example, the dataset management unit classifies the generated images into categories such as traffic accidents, natural disasters, and mechanical failures. In this way, the use of the dataset management unit improves the efficiency of dataset management. Some or all of the above-described processing in the dataset management unit may be performed using AI or without using AI. For example, the dataset management unit can input the generated images to the AI, and the AI can classify the images and add them to the dataset.

A response determination AI unit configured to determine an appropriate response based on the situation during driving is provided. The response determination AI unit determines an appropriate response based on the situation input to the generative AI. For example, the response determination AI unit instructs to take evasive action if there is an obstacle ahead. The response determination AI unit can also instruct to reduce speed if the road is slippery. Furthermore, the response determination AI unit can instruct to turn on the lights if visibility is poor. In this way, the use of the response determination AI unit enables quick determination of appropriate responses. Some or all of the above-described processing in the response determination AI unit may be performed using AI or without using AI. For example, the response determination AI unit can determine an appropriate response based on the situation input to the generative AI and instruct the driver accordingly.

The image generation unit can generate images reproducing irregular situations that are not included in normal datasets. For example, the image generation unit generates images reproducing irregular situations that are not included in normal datasets using generative AI. For example, the image generation unit generates images reproducing situations where animals suddenly jump onto the road. The image generation unit can also generate images reproducing driving conditions under abnormal weather. For example, the image generation unit generates images reproducing driving conditions in heavy rain or snow. Furthermore, the image generation unit can generate images reproducing driving conditions at night or in fog using generative AI. In this way, generating images reproducing irregular situations improves the recognition accuracy of the AI. Some or all of the above-described processing in the image generation unit may be performed using generative AI or without using generative AI. For example, the image generation unit can add images generated using generative AI to the dataset and train the AI.

The prompt input unit can input irregular situations occurring during driving to the generative AI in real time as prompts using speech recognition technology. For example, the prompt input unit inputs situations such as "There is an obstacle ahead" by voice during driving. The prompt input unit can also input situations such as "The road is slippery" by voice during driving. Furthermore, the prompt input unit can input situations such as "Visibility is poor" by voice during driving. In this way, inputting prompts in real time enables quick responses. Some or all of the above-described processing in the prompt input unit may be performed using generative AI or without using generative AI. For example, the prompt input unit can input situations entered using speech recognition technology to the generative AI, and the generative AI can determine an appropriate response based on the situation.

The response determination unit can determine an appropriate response based on the situation input to the generative AI. For example, the response determination unit determines an appropriate response based on the situation input to the generative AI. For example, the response determination unit instructs to take evasive action if there is an obstacle ahead. The response determination unit can also instruct to reduce speed if the road is slippery. Furthermore, the response determination unit can instruct to turn on the lights if visibility is poor. In this way, the use of generative AI enables quick determination of appropriate responses. Some or all of the above-described processing in the response determination unit may be performed using generative AI or without using generative AI. For example, the response determination unit can determine an appropriate response based on the situation input to the generative AI and instruct the driver accordingly.

The image generation unit can estimate the driver's emotion and adjust the content of the generated images based on the estimated driver's emotion. For example, if the driver is nervous, the generative AI generates a calm landscape image to ease the tension. The image generation unit can also generate a refreshing natural landscape image if the driver is tired. Furthermore, if the driver is excited, the generative AI can generate a quiet night view image to help the driver regain composure. In this way, by generating images according to the driver's emotion, images suitable for the driver's condition can be provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the image generation unit may be performed using generative AI or without using generative AI. For example, the image generation unit can input the driver's emotion data to the generative AI, and the generative AI can generate appropriate images based on the emotion.

The image generation unit can reproduce more diverse irregular events by including visual information from different viewpoints and angles in the generated images. For example, the image generation unit generates images including visual information from different viewpoints and angles using generative AI. For example, the image generation unit generates images reproducing traffic congestion from an overhead view of the road. The image generation unit can also generate images reproducing congestion in a parking lot from a side view of a vehicle. Furthermore, the image generation unit can generate images reproducing congestion at a crosswalk from a pedestrian's viewpoint. In this way, including visual information from different viewpoints and angles enables reproduction of more diverse irregular events. Some or all of the above-described processing in the image generation unit may be performed using generative AI or without using generative AI. For example, the image generation unit can add images generated using generative AI to the dataset and train the AI.

The image generation unit can provide more realistic scenarios by reflecting different times of day and seasonal changes in the generated images. For example, the image generation unit generates images reflecting different times of day and seasonal changes using generative AI. For example, the image generation unit generates images reproducing nighttime road conditions. The image generation unit can also generate images reproducing snowy road conditions in winter. Furthermore, the image generation unit can generate images reproducing road conditions with fallen leaves in autumn. In this way, reflecting different times of day and seasonal changes provides more realistic scenarios. Some or all of the above-described processing in the image generation unit may be performed using generative AI or without using generative AI. For example, the image generation unit can add images generated using generative AI to the dataset and train the AI.

The image generation unit can estimate the driver's emotion and determine the priority of the images to be generated based on the estimated driver's emotion. For example, if the driver is nervous, the generative AI preferentially generates images with a relaxing effect. The image generation unit can also preferentially generate images with a refreshing effect if the driver is tired. Furthermore, if the driver is excited, the generative AI can preferentially generate images to help the driver regain composure. In this way, by determining the priority of images according to the driver's emotion, images suitable for the driver's condition can be preferentially provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the image generation unit may be performed using generative AI or without using generative AI. For example, the image generation unit can input the driver's emotion data to the generative AI, and the generative AI can generate appropriate images based on the emotion.

The image generation unit can provide more diverse scenarios by reflecting different traffic conditions and road conditions in the generated images. For example, the image generation unit generates images reflecting different traffic conditions and road conditions using generative AI. For example, the image generation unit generates images reproducing road conditions during traffic congestion. The image generation unit can also generate images reproducing road conditions during construction. Furthermore, the image generation unit can generate images reproducing road conditions at accident sites. In this way, reflecting different traffic conditions and road conditions provides more diverse scenarios. Some or all of the above-described processing in the image generation unit may be performed using generative AI or without using generative AI. For example, the image generation unit can add images generated using generative AI to the dataset and train the AI.

The image generation unit can provide more realistic scenarios by reflecting different weather conditions in the generated images. For example, the image generation unit generates images reflecting different weather conditions using generative AI. For example, the image generation unit generates images reproducing road conditions during rain. The image generation unit can also generate images reproducing road conditions on snowy days. Furthermore, the image generation unit can generate images reproducing road conditions in fog. In this way, reflecting different weather conditions provides more realistic scenarios. Some or all of the above-described processing in the image generation unit may be performed using generative AI or without using generative AI. For example, the image generation unit can add images generated using generative AI to the dataset and train the AI.

The dataset addition unit can estimate the driver's emotion and select images to be added to the dataset based on the estimated driver's emotion. For example, if the driver is nervous, images with a relaxing effect are added to the dataset. The dataset addition unit can also add images with a refreshing effect to the dataset if the driver is tired. Furthermore, if the driver is excited, images to help the driver regain composure can be added to the dataset. In this way, by adding images to the dataset according to the driver's emotion, the quality of the dataset is improved. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the dataset addition unit may be performed using AI or without using AI. For example, the dataset addition unit can input the driver's emotion data to the AI, and the AI can select appropriate images based on the emotion and add them to the dataset.

The dataset addition unit can add a function to automatically generate and manage metadata of images when adding them to the dataset. For example, the dataset addition unit automatically generates metadata such as the date and time and location of image capture and adds it to the dataset. The dataset addition unit can also automatically generate tags related to the content of the image and add them to the dataset. Furthermore, the dataset addition unit can automatically generate metadata such as image resolution and format information and add it to the dataset. In this way, automatically generating and managing image metadata improves the efficiency of dataset management. Some or all of the above-described processing in the dataset addition unit may be performed using AI or without using AI. For example, the dataset addition unit can input image metadata to the AI, and the AI can generate the metadata and add it to the dataset.

The dataset addition unit can add a function to evaluate the quality of images to be added to the dataset and automatically exclude low-quality images. For example, the dataset addition unit automatically excludes images with low resolution. The dataset addition unit can also automatically exclude images with a lot of noise. Furthermore, the dataset addition unit can automatically exclude blurry images. In this way, automatically excluding low-quality images improves the quality of the dataset. Some or all of the above-described processing in the dataset addition unit may be performed using AI or without using AI. For example, the dataset addition unit can input image quality to the AI, and the AI can evaluate the quality and exclude low-quality images.

The dataset addition unit can estimate the driver's emotion and determine the priority of images to be added to the dataset based on the estimated driver's emotion. For example, if the driver is nervous, images with a relaxing effect are preferentially added to the dataset. The dataset addition unit can also preferentially add images with a refreshing effect to the dataset if the driver is tired. Furthermore, if the driver is excited, images to help the driver regain composure can be preferentially added to the dataset. In this way, by determining the priority of images according to the driver's emotion, the quality of the dataset is improved. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the dataset addition unit may be performed using AI or without using AI. For example, the dataset addition unit can input the driver's emotion data to the AI, and the AI can select appropriate images based on the emotion and add them to the dataset.

The dataset addition unit can add a function to evaluate the relevance of images when adding them to the dataset and preferentially add highly relevant images. For example, the dataset addition unit preferentially adds images whose content is related to the current driving situation to the dataset. The dataset addition unit can also preferentially add images whose content is related to past driving history. Furthermore, the dataset addition unit can preferentially add images whose content is related to specific driving scenarios. In this way, preferentially adding highly relevant images improves the quality of the dataset. Some or all of the above-described processing in the dataset addition unit may be performed using AI or without using AI. For example, the dataset addition unit can input image relevance to the AI, and the AI can evaluate the relevance, select highly relevant images, and add them to the dataset.

The dataset addition unit can add a function to evaluate the diversity of images when adding them to the dataset and preferentially add highly diverse images. For example, the dataset addition unit preferentially adds images taken from different viewpoints and angles to the dataset. The dataset addition unit can also preferentially add images reflecting different times of day and seasonal changes to the dataset. Furthermore, the dataset addition unit can preferentially add images reflecting different traffic conditions and road conditions to the dataset. In this way, preferentially adding highly diverse images improves the quality of the dataset. Some or all of the above-described processing in the dataset addition unit may be performed using AI or without using AI. For example, the dataset addition unit can input image diversity to the AI, and the AI can evaluate the diversity, select highly diverse images, and add them to the dataset.

The prompt input unit can estimate the driver's emotion and adjust the content of the prompt based on the estimated driver's emotion. For example, if the driver is nervous, the prompt input unit provides simple and clear prompts. The prompt input unit can also provide prompts with detailed information if the driver is relaxed. Furthermore, if the driver is in a hurry, the prompt input unit can provide prompts that enable quick responses. In this way, by providing prompts according to the driver's emotion, prompts suitable for the driver's condition can be provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the prompt input unit may be performed using AI or without using AI. For example, the prompt input unit can input the driver's emotion data to the AI, and the AI can generate appropriate prompts based on the emotion.

The prompt input unit can refer to the driver's past driving history when inputting prompts and generate optimal prompts. For example, the prompt input unit preferentially provides prompts that were used in similar situations in the past. The prompt input unit can also provide prompts used at specific times or locations based on past driving history. Furthermore, the prompt input unit can analyze past driving history and provide the most effective prompts. In this way, referring to past driving history enables optimal prompts to be provided. Some or all of the above-described processing in the prompt input unit may be performed using AI or without using AI. For example, the prompt input unit can input the driver's past driving history to the AI, and the AI can analyze the history and generate optimal prompts.

The prompt input unit can analyze the driver's current driving situation in real time when inputting prompts and generate optimal prompts. For example, the prompt input unit analyzes the current traffic situation in real time and provides appropriate prompts. The prompt input unit can also analyze the current weather conditions in real time and provide appropriate prompts. Furthermore, the prompt input unit can analyze the current road conditions in real time and provide appropriate prompts. In this way, analyzing the current driving situation in real time enables optimal prompts to be provided. Some or all of the above-described processing in the prompt input unit may be performed using AI or without using AI. For example, the prompt input unit can input the driver's current driving situation to the AI, and the AI can analyze the situation in real time and generate optimal prompts.

The prompt input unit can estimate the driver's emotion and determine the priority of prompts based on the estimated driver's emotion. For example, if the driver is nervous, the prompt input unit preferentially provides prompts with a relaxing effect. The prompt input unit can also preferentially provide prompts with a refreshing effect if the driver is tired. Furthermore, if the driver is excited, the prompt input unit can preferentially provide prompts to help the driver regain composure. In this way, by determining the priority of prompts according to the driver's emotion, prompts suitable for the driver's condition can be preferentially provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the prompt input unit may be performed using AI or without using AI. For example, the prompt input unit can input the driver's emotion data to the AI, and the AI can generate appropriate prompts based on the emotion.

The prompt input unit can generate optimal prompts by considering the driver's geographic location information when inputting prompts. For example, the prompt input unit provides appropriate prompts by considering the current traffic situation at the current location. The prompt input unit can also provide appropriate prompts by considering the current weather conditions at the current location. Furthermore, the prompt input unit can provide appropriate prompts by considering the current road conditions at the current location. In this way, considering geographic location information enables optimal prompts to be provided. Some or all of the above-described processing in the prompt input unit may be performed using AI or without using AI. For example, the prompt input unit can input the driver's geographic location information to the AI, and the AI can generate optimal prompts based on the information.

The prompt input unit can analyze the driver's social media activity when inputting prompts and generate relevant prompts. For example, the prompt input unit provides appropriate prompts based on information shared by the driver on social media. The prompt input unit can also analyze the driver's social media activity history and provide relevant prompts. Furthermore, the prompt input unit can provide appropriate prompts based on information from accounts followed by the driver on social media. In this way, analyzing social media activity enables relevant prompts to be provided. Some or all of the above-described processing in the prompt input unit may be performed using AI or without using AI. For example, the prompt input unit can input the driver's social media activity to the AI, and the AI can analyze the activity and generate relevant prompts.

The response determination unit can estimate the driver's emotion and adjust the content of the response based on the estimated driver's emotion. For example, if the driver is nervous, the response determination unit provides a response with a relaxing effect. The response determination unit can also provide a response with a refreshing effect if the driver is tired. Furthermore, if the driver is excited, the response determination unit can provide a response to help the driver regain composure. In this way, by providing responses according to the driver's emotion, responses suitable for the driver's condition can be provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the response determination unit may be performed using AI or without using AI. For example, the response determination unit can input the driver's emotion data to the AI, and the AI can generate appropriate responses based on the emotion.

The response determination unit can refer to past response history when determining a response and select the optimal response. For example, the response determination unit preferentially selects responses that were taken in similar situations in the past. The response determination unit can also select responses taken at specific times or locations based on past response history. Furthermore, the response determination unit can analyze past response history and select the most effective response. In this way, referring to past response history enables optimal responses to be provided. Some or all of the above-described processing in the response determination unit may be performed using AI or without using AI. For example, the response determination unit can input past response history to the AI, and the AI can analyze the history and select the optimal response.

The response determination unit can analyze the current driving situation in real time when determining a response and select the optimal response. For example, the response determination unit analyzes the current traffic situation in real time and selects an appropriate response. The response determination unit can also analyze the current weather conditions in real time and select an appropriate response. Furthermore, the response determination unit can analyze the current road conditions in real time and select an appropriate response. In this way, analyzing the current driving situation in real time enables optimal responses to be provided. Some or all of the above-described processing in the response determination unit may be performed using AI or without using AI. For example, the response determination unit can input the current driving situation to the AI, and the AI can analyze the situation in real time and select the optimal response.

The response determination unit can estimate the driver's emotion and determine the priority of responses based on the estimated driver's emotion. For example, if the driver is nervous, the response determination unit preferentially provides responses with a relaxing effect. The response determination unit can also preferentially provide responses with a refreshing effect if the driver is tired. Furthermore, if the driver is excited, the response determination unit can preferentially provide responses to help the driver regain composure. In this way, by determining the priority of responses according to the driver's emotion, responses suitable for the driver's condition can be preferentially provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the response determination unit may be performed using AI or without using AI. For example, the response determination unit can input the driver's emotion data to the AI, and the AI can generate appropriate responses based on the emotion.

The response determination unit can select the optimal response by considering the driver's geographic location information when determining a response. For example, the response determination unit selects an appropriate response by considering the current traffic situation at the current location. The response determination unit can also select an appropriate response by considering the current weather conditions at the current location. Furthermore, the response determination unit can select an appropriate response by considering the current road conditions at the current location. In this way, considering geographic location information enables optimal responses to be provided. Some or all of the above-described processing in the response determination unit may be performed using AI or without using AI. For example, the response determination unit can input the driver's geographic location information to the AI, and the AI can generate the optimal response based on the information.

The response determination unit can analyze the driver's social media activity when determining a response and select relevant responses. For example, the response determination unit selects an appropriate response based on information shared by the driver on social media. The response determination unit can also analyze the driver's social media activity history and select relevant responses. Furthermore, the response determination unit can select an appropriate response based on information from accounts followed by the driver on social media. In this way, analyzing social media activity enables relevant responses to be provided. Some or all of the above-described processing in the response determination unit may be performed using AI or without using AI. For example, the response determination unit can input the driver's social media activity to the AI, and the AI can analyze the activity and generate relevant responses.

The system according to the embodiment is not limited to the above-described examples and can be variously modified as follows, for example.

The autonomous driving system can estimate the driver's emotion and provide feedback to the driver based on the estimated emotion. For example, if the driver is nervous, the system suggests breathing techniques or music to help the driver relax. If the driver is tired, the system can prompt the driver to take a break. Furthermore, if the driver is excited, the system can provide advice to help the driver calm down. In this way, by providing feedback according to the driver's emotion, the driver's condition can be optimized and safe driving can be supported. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the feedback providing unit may be performed using generative AI or without using generative AI. For example, the feedback providing unit can input the driver's emotion data to the generative AI, and the generative AI can generate appropriate feedback based on the emotion.

The autonomous driving system can analyze the driver's past driving history and provide optimal driving assistance based on the driver's driving style. For example, for drivers who frequently use sudden braking in the past, the system provides assistance to encourage deceleration in advance. For drivers who frequently drive on highways in the past, the system can provide assistance to maintain optimal following distance on highways. Furthermore, for drivers who frequently drive at night in the past, the system can provide assistance to improve nighttime visibility. In this way, providing assistance according to the driver's driving style can improve driving safety and comfort. The analysis of driving history may be performed using AI or without using AI. For example, driving history data can be input to the AI, and the AI can analyze the data and generate optimal driving assistance.

The autonomous driving system can estimate the driver's emotion and monitor the driver's stress level based on the estimated emotion. For example, if the driver is experiencing high stress, the system prompts the driver to take a break. If the driver is at a low stress level, the system can recommend continuing to drive. Furthermore, if the driver's stress level changes rapidly, the system can identify the cause and propose appropriate countermeasures. In this way, by monitoring the driver's stress level, the driver's health and safety can be supported. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the stress monitoring unit may be performed using generative AI or without using generative AI. For example, the stress monitoring unit can input the driver's emotion data to the generative AI, and the generative AI can perform appropriate monitoring based on the emotion.

The autonomous driving system can estimate the driver's emotion and evaluate the driver's concentration based on the estimated emotion. For example, if the driver is focused, the system recommends continuing to drive. If the driver is lacking concentration, the system can prompt the driver to take a break. Furthermore, if the driver's concentration drops sharply, the system can identify the cause and propose appropriate countermeasures. In this way, by evaluating the driver's concentration, driving safety can be improved. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the concentration evaluation unit may be performed using generative AI or without using generative AI. For example, the concentration evaluation unit can input the driver's emotion data to the generative AI, and the generative AI can perform appropriate evaluation based on the emotion.

The autonomous driving system can estimate the driver's emotion and adjust the driver's driving style based on the estimated emotion. For example, if the driver is nervous, the system adjusts the driving to be smoother. If the driver is relaxed, the system can make the driving more dynamic. Furthermore, if the driver is tired, the system can reduce speed to make driving safer. In this way, by providing a driving style according to the driver's emotion, driving safety and comfort can be improved. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the driving style adjustment unit may be performed using generative AI or without using generative AI. For example, the driving style adjustment unit can input the driver's emotion data to the generative AI, and the generative AI can generate an appropriate driving style based on the emotion.

The autonomous driving system can refer to the driver's past driving history and propose optimal routes based on the driver's driving patterns. For example, for drivers who frequently use a specific route in the past, the system preferentially proposes that route. For drivers who tend to avoid traffic congestion in the past, the system can propose routes that avoid congestion. Furthermore, for drivers who prefer to use highways in the past, the system can propose routes that use highways. In this way, proposing optimal routes according to the driver's driving patterns can improve driving efficiency and comfort. The reference to driving history may be performed using AI or without using AI. For example, driving history data can be input to the AI, and the AI can analyze the data and generate optimal routes.

The autonomous driving system can analyze the driver's current driving situation in real time and provide optimal driving assistance. For example, the system analyzes the current traffic situation in real time and provides assistance to avoid congestion. The system can also analyze the current weather conditions in real time and provide driving assistance in bad weather. Furthermore, the system can analyze the current road conditions in real time and provide assistance to avoid road construction or accidents. In this way, analyzing the current driving situation in real time enables optimal driving assistance to be provided. The real-time analysis of driving situation may be performed using AI or without using AI. For example, driving situation data can be input to the AI, and the AI can analyze the data in real time and generate optimal driving assistance.

The autonomous driving system can provide optimal driving assistance by considering the driver's geographic location information. For example, the system provides assistance to avoid congestion by considering the current traffic situation at the current location. The system can also provide driving assistance in bad weather by considering the current weather conditions at the current location. Furthermore, the system can provide assistance to avoid road construction or accidents by considering the current road conditions at the current location. In this way, considering geographic location information enables optimal driving assistance to be provided. The consideration of geographic location information may be performed using AI or without using AI. For example, geographic location information data can be input to the AI, and the AI can analyze the data and generate optimal driving assistance.

The autonomous driving system can analyze the driver's social media activity and provide optimal driving assistance based on the driver's interests and preferences. For example, the system proposes routes to places of interest based on information shared by the driver on social media. The system can also analyze the driver's social media activity history and provide relevant driving assistance. Furthermore, the system can propose routes to events or places of interest based on information from accounts followed by the driver on social media. In this way, analyzing social media activity enables driving assistance based on the driver's interests and preferences to be provided. The analysis of social media activity may be performed using AI or without using AI. For example, social media activity data can be input to the AI, and the AI can analyze the data and generate optimal driving assistance.

The autonomous driving system can estimate the driver's emotion and evaluate the driver's driving performance based on the estimated emotion. For example, if the driver is nervous, the system evaluates that the driving performance is decreased. If the driver is relaxed, the system can evaluate that the driving performance is improved. Furthermore, if the driver is tired, the system can also evaluate that the driving performance is decreased. In this way, by evaluating driving performance according to the driver's emotion, driving safety and efficiency can be improved. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the driving performance evaluation unit may be performed using generative AI or without using generative AI. For example, the driving performance evaluation unit can input the driver's emotion data to the generative AI, and the generative AI can perform appropriate evaluation based on the emotion.

The following is a brief description of the processing flow of Example 2 of the Embodiment.

Step 1: The image generation unit generates images for irregular events. For example, images reproducing irregular situations that are not included in normal datasets are generated using generative AI. Specifically, images reproducing situations such as animals suddenly jumping onto the road or driving conditions under abnormal weather (driving in heavy rain or snow, at night, or in fog) are generated.

Step 2: The dataset addition unit adds images generated by the image generation unit to a dataset. For example, the generated images are integrated into an existing dataset and used for AI training. The generated images are also classified and added to appropriate categories such as traffic accidents, natural disasters, and mechanical failures.

Step 3: The prompt input unit inputs situations during driving as prompts. For example, irregular situations occurring during driving are input to the generative AI in real time as prompts using speech recognition technology. Specifically, situations such as "There is an obstacle ahead," "The road is slippery," and "Visibility is poor" are input by voice.

Step 4: The response determination unit determines an appropriate response based on the situation input by the prompt input unit. For example, the response determination unit determines an appropriate response based on the situation input to the generative AI, instructs to take evasive action if there is an obstacle ahead, instructs to reduce speed if the road is slippery, and instructs to turn on the lights if visibility is poor.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described image generation unit, dataset addition unit, prompt input unit, and response determination unit is implemented, for example, in at least one of the smart device 14 and the data processing apparatus 12. For example, the image generation unit is implemented by the control unit 46A of the smart device 14 and generates images reproducing irregular situations using generative AI. The dataset addition unit is implemented, for example, by the specific processing unit 290 of the data processing apparatus 12 and adds the generated images to the dataset. The prompt input unit is implemented, for example, by the control unit 46A of the smart device 14 and inputs situations during driving as prompts using speech recognition technology. The response determination unit is implemented, for example, by the specific processing unit 290 of the data processing apparatus 12 and determines an appropriate response based on the input situation. The correspondence between each unit and the device or control unit is not limited to the above examples and various modifications are possible.

### Second Embodiment

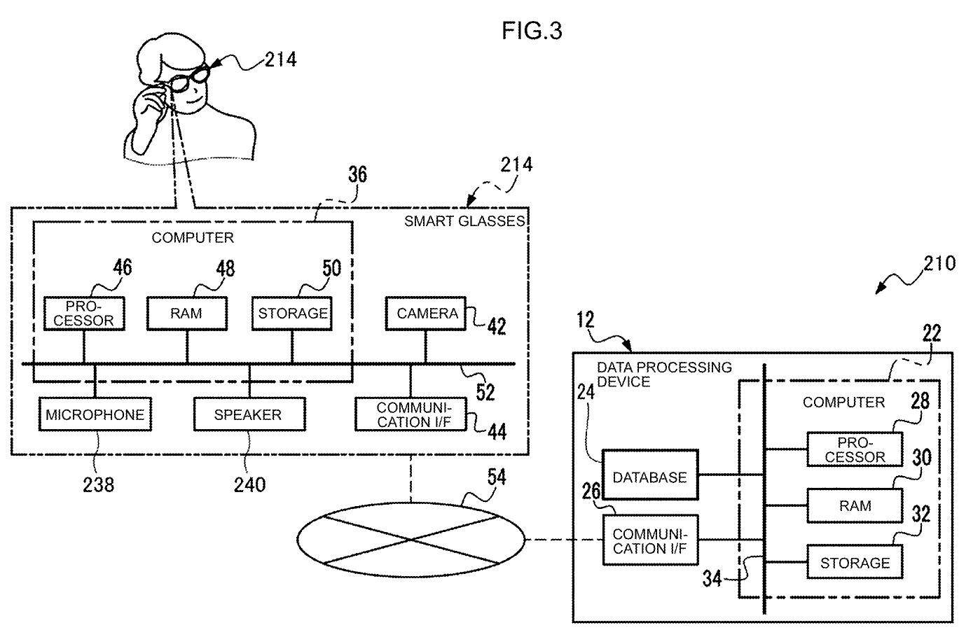

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

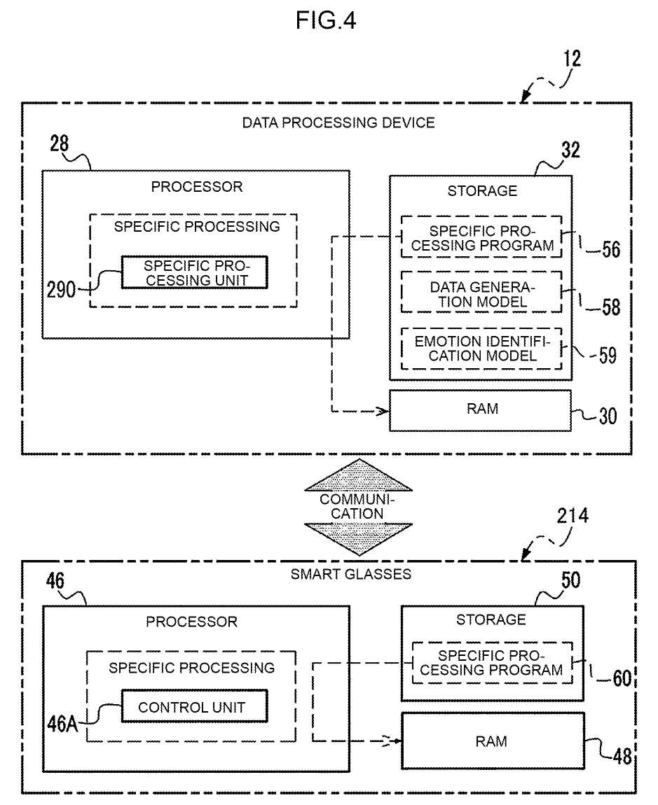

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described image generation unit, dataset addition unit, prompt input unit, and response determination unit is implemented, for example, in at least one of the smart glasses 214 and the data processing apparatus 12. For example, the image generation unit is implemented by the control unit 46A of the smart glasses 214 and generates images reproducing irregular situations using generative AI. The dataset addition unit is implemented, for example, by the specific processing unit 290 of the data processing apparatus 12 and adds the generated images to the dataset. The prompt input unit is implemented, for example, by the control unit 46A of the smart glasses 214 and inputs situations during driving as prompts using speech recognition technology. The response determination unit is implemented, for example, by the specific processing unit 290 of the data processing apparatus 12 and determines an appropriate response based on the input situation. The correspondence between each unit and the device or control unit is not limited to the above examples and various modifications are possible.

### Third Embodiment

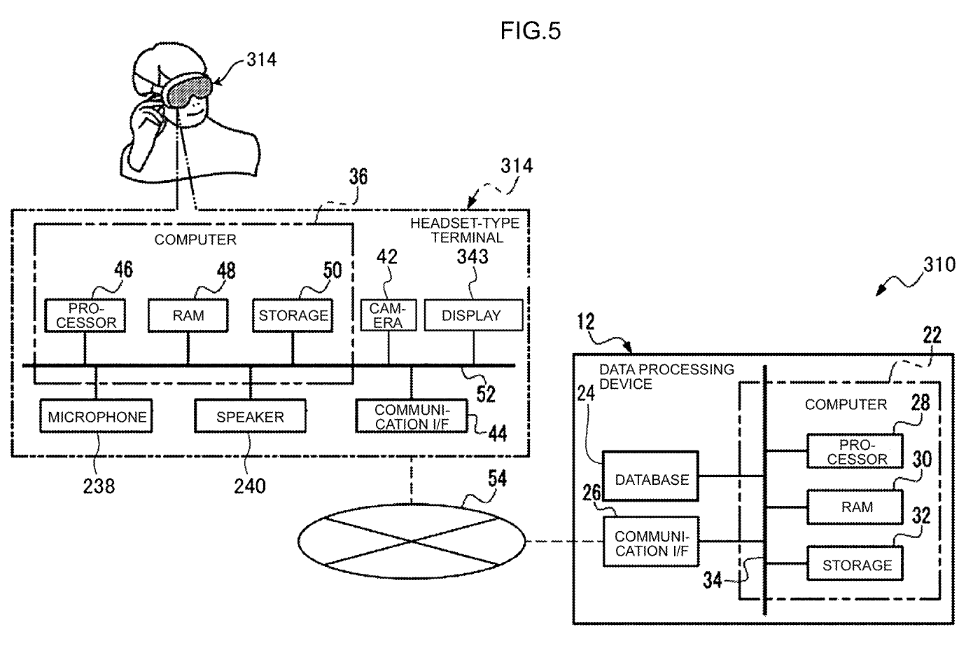

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

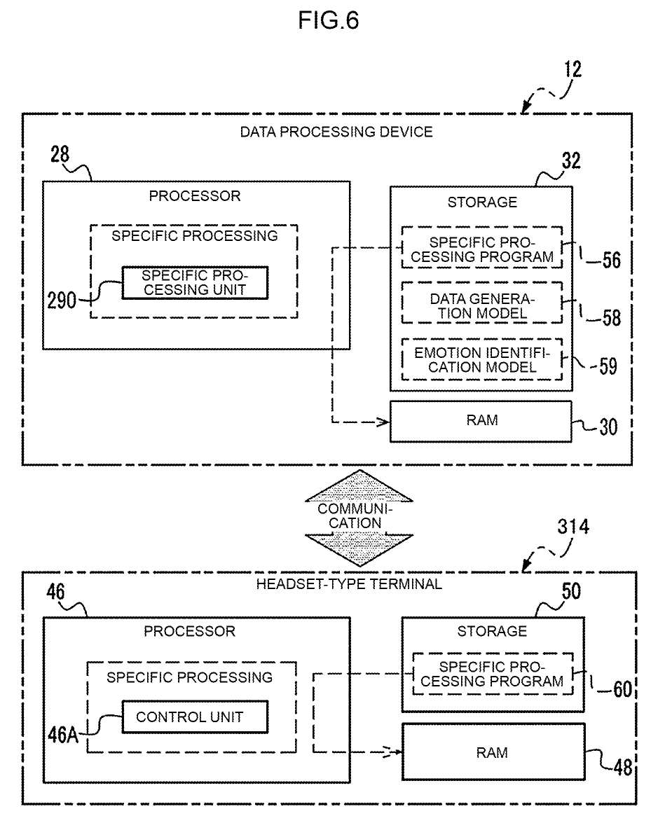

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described image generation unit, dataset addition unit, prompt input unit, and response determination unit is implemented, for example, in at least one of the headset-type terminal 314 and the data processing apparatus 12. For example, the image generation unit is implemented by the control unit 46A of the headset-type terminal 314 and generates images reproducing irregular situations using generative AI. The dataset addition unit is implemented, for example, by the specific processing unit 290 of the data processing apparatus 12 and adds the generated images to the dataset. The prompt input unit is implemented, for example, by the control unit 46A of the headset-type terminal 314 and inputs situations during driving as prompts using speech recognition technology. The response determination unit is implemented, for example, by the specific processing unit 290 of the data processing apparatus 12 and determines an appropriate response based on the input situation. The correspondence between each unit and the device or control unit is not limited to the above examples and various modifications are possible.

### Fourth Embodiment

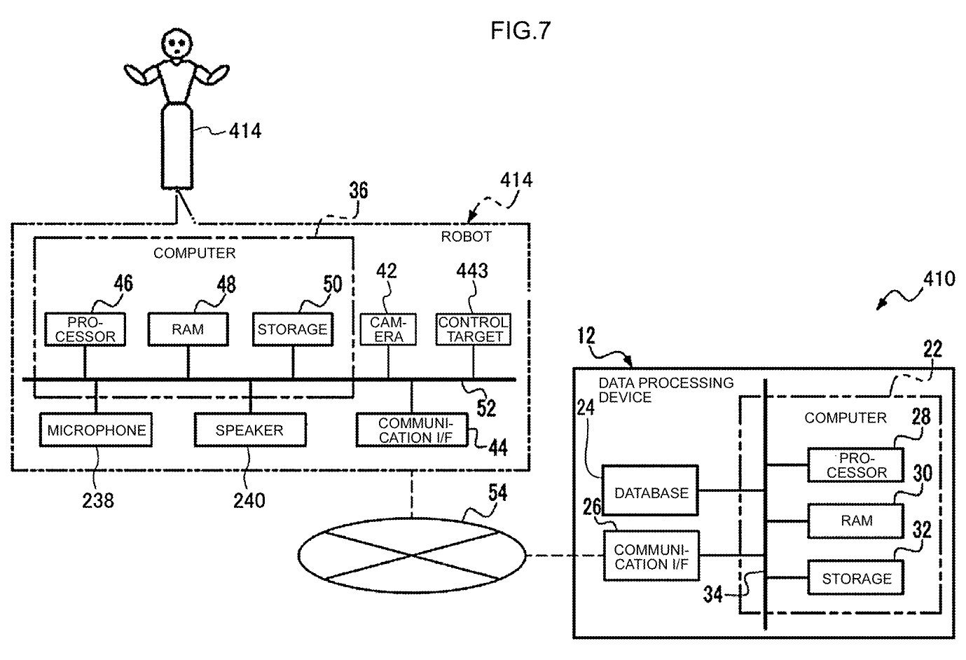

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

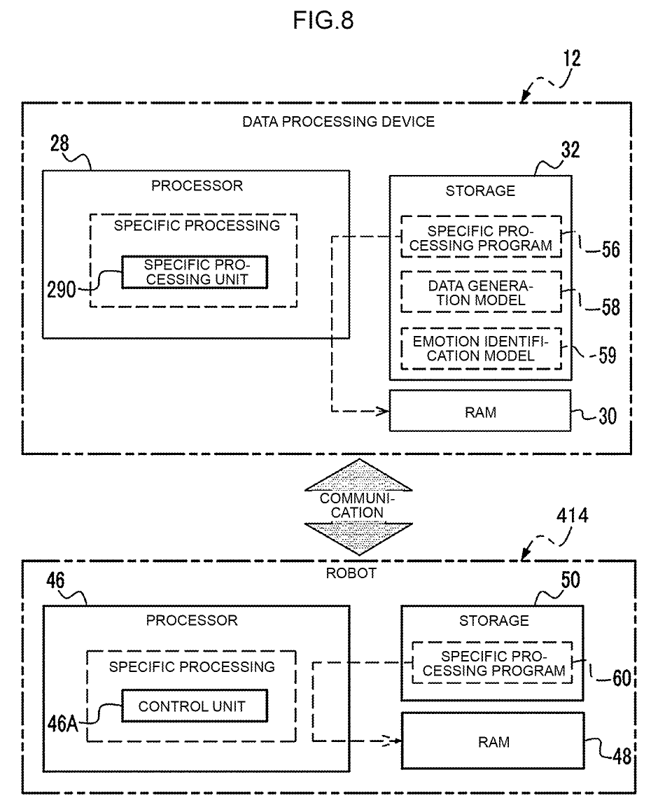

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described image generation unit, dataset addition unit, prompt input unit, and response determination unit is implemented, for example, in at least one of the robot 414 and the data processing apparatus 12. For example, the image generation unit is implemented by the control unit 46A of the robot 414 and generates images reproducing irregular situations using generative AI. The dataset addition unit is implemented, for example, by the specific processing unit 290 of the data processing apparatus 12 and adds the generated images to the dataset. The prompt input unit is implemented, for example, by the control unit 46A of the robot 414 and inputs situations during driving as prompts using speech recognition technology. The response determination unit is implemented, for example, by the specific processing unit 290 of the data processing apparatus 12 and determines an appropriate response based on the input situation. The correspondence between each unit and the device or control unit is not limited to the above examples and various modifications are possible.

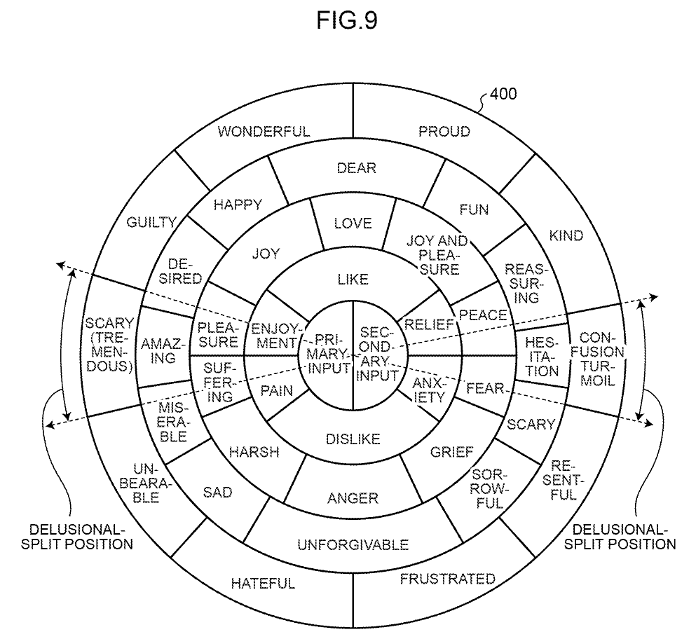

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, "pleasant" emotions are arranged, and on the lower side, "unpleasant" emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called "reactions," where sensations take precedence, are aligned. Additionally, in the right half of the emotion map, emotions belonging to the domain called "situations," where situational recognition takes precedence, are aligned.

In the emotion map, two emotions that promote learning are defined. One is a negative emotion around "repentance" or "reflection" on the situation side. In other words, when a negative emotion arises in the robot, like "I never want to feel this way again" or "I don't want to be scolded again." The other is an emotion around "desire" on the reaction side, which is positive. In other words, it is a positive feeling like "I want more" or "I want to know more."

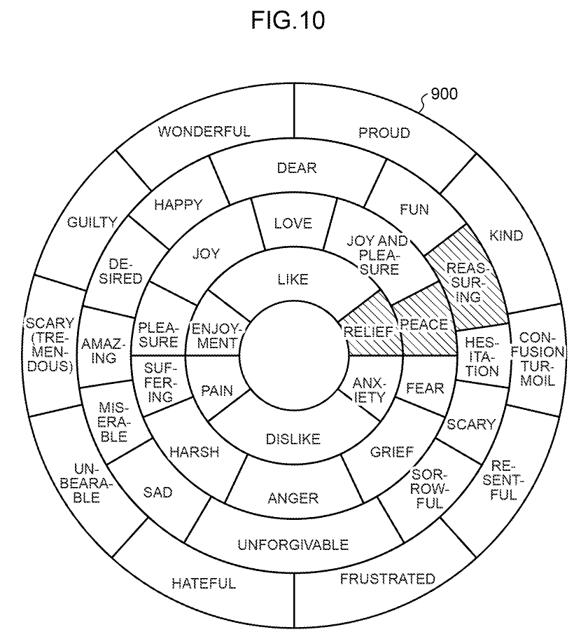

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like "reassured," "calm," and "confident" have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

[Additional Note 1] A system including: an image generation unit configured to generate images for irregular events; a dataset addition unit configured to add images generated by the image generation unit to a dataset; a prompt input unit configured to input situations during driving as prompts; and a response determination unit configured to determine an appropriate response based on the situation input by the prompt input unit.

[Additional Note 2] The system according to Additional Note 1, further including a generative AI unit configured to generate images using generative AI.

[Additional Note 3] The system according to Additional Note 1, further including a speech recognition unit configured to input situations using speech recognition technology.

[Additional Note 4] The system according to Additional Note 1, further including a dataset management unit configured to add generated images to the dataset.

[Additional Note 5] The system according to Additional Note 1, further including a response determination AI unit configured to determine an appropriate response based on the situation during driving.

[Additional Note 6] The system according to Additional Note 1, wherein the image generation unit is configured to generate images reproducing irregular situations that are not included in a normal dataset.

[Additional Note 7] The system according to Additional Note 1, wherein the prompt input unit is configured to input irregular situations occurring during driving to the generative AI in real time as prompts using speech recognition technology.

[Additional Note 8] The system according to Additional Note 1, wherein the response determination unit is configured to determine an appropriate response based on the situation input to the generative AI.

[Additional Note 9] The system according to Additional Note 1, wherein the image generation unit is configured to estimate the driver's emotion and adjust the content of the generated image based on the estimated driver's emotion.

[Additional Note 10] The system according to Additional Note 1, wherein the image generation unit is configured to include visual information from different viewpoints and angles in the generated images to reproduce more diverse irregular events.

[Additional Note 11] The system according to Additional Note 1, wherein the image generation unit is configured to reflect different times of day and seasonal changes in the generated images to provide more realistic scenarios.

[Additional Note 12] The system according to Additional Note 1, wherein the image generation unit is configured to estimate the driver's emotion and determine the priority of the images to be generated based on the estimated driver's emotion.

[Additional Note 13] The system according to Additional Note 1, wherein the image generation unit is configured to reflect different traffic conditions and road conditions in the generated images to provide more diverse scenarios.

[Additional Note 14] The system according to Additional Note 1, wherein the image generation unit is configured to reflect different weather conditions in the generated images to provide more realistic scenarios.

[Additional Note 15] The system according to Additional Note 1, wherein the dataset addition unit is configured to estimate the driver's emotion and select images to be added to the dataset based on the estimated driver's emotion.

[Additional Note 16] The system according to Additional Note 1, wherein the dataset addition unit is configured to automatically generate and manage metadata of images when adding them to the dataset.

[Additional Note 17] The system according to Additional Note 1, wherein the dataset addition unit is configured to evaluate the quality of images to be added to the dataset and automatically exclude low-quality images.

[Additional Note 18] The system according to Additional Note 1, wherein the dataset addition unit is configured to estimate the driver's emotion and determine the priority of images to be added to the dataset based on the estimated driver's emotion.

[Additional Note 19] The system according to Additional Note 1, wherein the dataset addition unit is configured to evaluate the relevance of images when adding them to the dataset and preferentially add highly relevant images.

[Additional Note 20] The system according to Additional Note 1, wherein the dataset addition unit is configured to evaluate the diversity of images when adding them to the dataset and preferentially add highly diverse images.

[Additional Note 21] The system according to Additional Note 1, wherein the prompt input unit is configured to estimate the driver's emotion and adjust the content of the prompt based on the estimated driver's emotion.

[Additional Note 22] The system according to Additional Note 1, wherein the prompt input unit is configured to refer to the driver's past driving history when inputting prompts and generate optimal prompts.

[Additional Note 23] The system according to Additional Note 1, wherein the prompt input unit is configured to analyze the driver's current driving situation in real time when inputting prompts and generate optimal prompts.

[Additional Note 24] The system according to Additional Note 1, wherein the prompt input unit is configured to estimate the driver's emotion and determine the priority of prompts based on the estimated driver's emotion.

[Additional Note 25] The system according to Additional Note 1, wherein the prompt input unit is configured to generate optimal prompts by considering the driver's geographic location information when inputting prompts.

[Additional Note 26] The system according to Additional Note 1, wherein the prompt input unit is configured to analyze the driver's social media activity when inputting prompts and generate relevant prompts.

[Additional Note 27] The system according to Additional Note 1, wherein the response determination unit is configured to estimate the driver's emotion and adjust the content of the response based on the estimated driver's emotion.

[Additional Note 28] The system according to Additional Note 1, wherein the response determination unit is configured to refer to past response history when determining a response and select the optimal response.

[Additional Note 29] The system according to Additional Note 1, wherein the response determination unit is configured to analyze the current driving situation in real time when determining a response and select the optimal response.

[Additional Note 30] The system according to Additional Note 1, wherein the response determination unit is configured to estimate the driver's emotion and determine the priority of responses based on the estimated driver's emotion.

[Additional Note 31] The system according to Additional Note 1, wherein the response determination unit is configured to select the optimal response by considering the driver's geographic location information when determining a response.

[Additional Note 32] The system according to Additional Note 1, wherein the response determination unit is configured to analyze the driver's social media activity when determining a response and select relevant responses.

What is claimed is:

1. A system comprising: an image generation unit configured to generate images for irregular events; a dataset addition unit configured to add images generated by the image generation unit to a dataset; a prompt input unit configured to input situations during driving as prompts; and a response determination unit configured to determine an appropriate response based on the situation input by the prompt input unit.

2. The system according to claim 1, further comprising a generative AI unit configured to generate images using generative AI.

3. The system according to claim 1, further comprising a speech recognition unit configured to input situations using speech recognition technology.

4. The system according to claim 1, further comprising a dataset management unit configured to add generated images to the dataset.

5. The system according to claim 1, further comprising a response determination AI unit configured to determine an appropriate response based on the situation during driving.

6. The system according to claim 1, wherein the image generation unit is configured to generate images reproducing irregular situations that are not included in a normal dataset.

7. The system according to claim 1, wherein the prompt input unit is configured to input irregular situations occurring during driving to the generative AI in real time as prompts using speech recognition technology.

8. The system according to claim 1, wherein the response determination unit is configured to determine an appropriate response based on the situation input to the generative AI.
